(19) United States
(12) Patent Application Publication
(10) Pub. No.: US 2023/0228294 A1
(43) Pub. Date: Jul. 20, 2023

(54) TELESCOPIC COVER

(71) Applicant: FANUC CORPORATION, Yamanashi (JP)

(72) Inventor: Ryutaro ISHIKAWA, Yamanashi (JP)

(73) Assignee: FANUC CORPORATION, Yamanashi (JP)

(21) Appl. No.: 17/926,782

(22) PCT Filed: Jun. 14, 2021
(86) PCT No.: PCT/JP2021/022474

§ 371 Date: Nov. 21, 2022

(30) Foreign Application Priority Data
Jun. 16, 2020 (JP) 2020-103609

(51) Int. Cl. F16C 29/08; B23Q 11/08

(52) U.S. Cl. CPC F16C 29/088; B23Q 11/0825

(57) ABSTRACT

A telescopic cover for covering a linear motion mechanism in which a movable part is driven in a horizontal direction. The telescopic cover includes a plurality of cover pieces arranged in a nested manner and supported in a movable manner in a driving direction of the movable part. Of two internally and externally adjoining cover pieces, an outer cover piece has a wiper for wiping an outer surface of an inner cover piece. The inner cover piece has a weir part standing upright from the outer surface thereof toward an inner surface of the outer cover piece at an edge of an area constantly overlapping the outer cover piece, and a cutaway part formed by cutting away at least a portion of the weir part or the area to communicate between an inside and an outside of the inner cover piece.

### TECHNICAL FIELD

The present disclosure relates to a telescopic cover.

### BACKGROUND

A sliding-surface cover having a telescopic structure, in which a plurality of covers are stacked in a nested manner, is used to prevent chips and the like from falling onto the sliding surface of a machine tool (for example, see Japanese Unexamined Utility Model Application, Publication No. Hei 4-2548).

In this sliding-surface cover, a collecting chute into which chips and the like that have entered overlapping portions of the stacked covers are collected and through which the chips and the like are discharged to the outside of the sliding surface is provided on an end face of each cover.

### SUMMARY

An aspect of the present disclosure is a telescopic cover for covering a linear motion mechanism in which a movable part is driven in a horizontal direction. The telescopic cover includes a plurality of cover pieces arranged in a nested manner and supported in a relatively movable manner in a driving direction of the movable part. Of two internally and externally adjoining cover pieces, an outer cover piece has a wiper for wiping an outer surface of an inner cover piece. The inner cover piece has a weir part standing upright from the outer surface thereof toward an inner surface of the outer cover piece at an edge of an area constantly overlapping the outer cover piece, and a cutaway part formed by cutting away at least a portion of the weir part or the area to communicate between an inside and an outside of the inner cover piece. The cutaway part is provided at a position different from a position of the linear motion mechanism in the horizontal direction perpendicular to the driving direction.

### BRIEF DESCRIPTION OF DRAWINGS

FIG. 1 shows the overall structure of a telescopic cover according to an embodiment of the present disclosure.

FIG. 2 is a plan view of the telescopic cover in FIG. 1.

FIG. 3 is a sectional view of the telescopic cover in FIG. 1, in a contracted state.

FIG. 4 is a perspective view of a second cover piece or a third cover piece of the telescopic cover in FIG. 1.

FIG. 5 is a sectional view of the telescopic cover in FIG. 1, in an extended state.

FIG. 6 is a perspective view of a first modification of the second cover piece or the third cover piece of the telescopic cover in FIG. 1.

FIG. 7 is a perspective view of a second modification of the second cover piece or the third cover piece of the telescopic cover in FIG. 1.

FIG. 8 is a perspective view of a third modification of the second cover piece or the third cover piece of the telescopic cover in FIG. 1.

### DETAILED DESCRIPTION OF THE EMBODIMENTS

A telescopic cover 1 according to an embodiment of the present disclosure will be described below with reference to the drawings.

The telescopic cover 1 according to this embodiment is disposed on, for example, a stage of a machine tool.

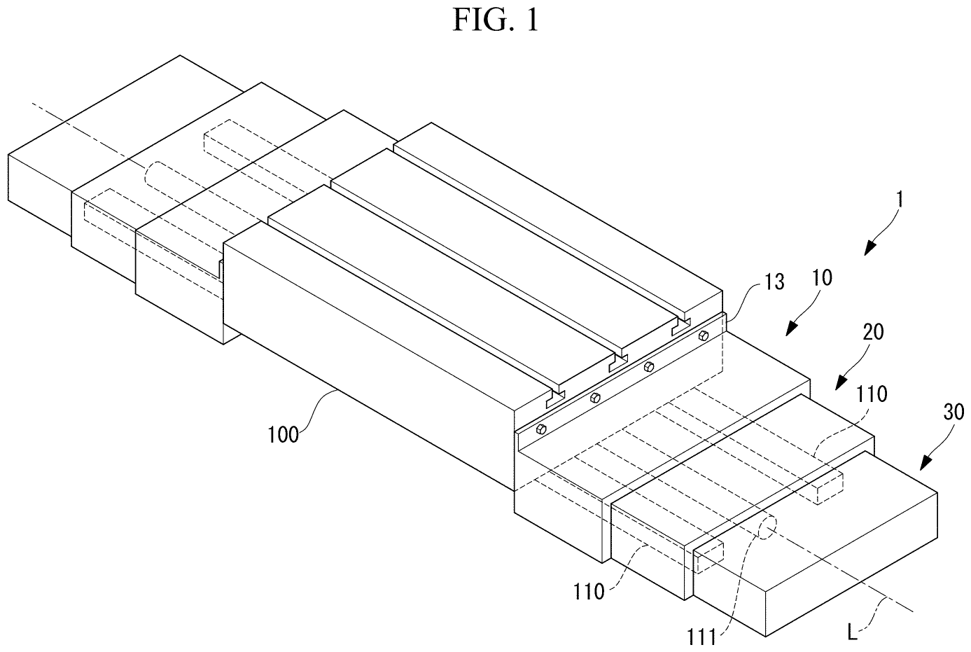

As shown in FIG. 1, the stage includes a table (movable part) 100, on which a workpiece is to be loaded, and guide rails (linear motion mechanism) 110 that support the table 100 in a manner allowing movement in the direction of the horizontal axis L. The stage also includes a ball thread (linear motion mechanism) 111 that is rotated about the axis L by the operation of a motor (not shown) to drive the table 100 in the axis L direction.

There are two guide rails 110 that are fixed to a base (not shown) installed on the floor and are disposed at a distance from each other so as to be parallel to the axis L. The ball thread 111 is disposed parallel to the guide rails 110 with a certain space therefrom, substantially in the middle of the two guide rails 110 in the direction in which the guide rails 110 are spaced apart.

A nut (not shown) that meshes with the ball thread 111 is fixed to the bottom of the table 100 via a bracket (not shown). The nut converts the rotation of the ball thread 111 into linear motion in the direction along the guide rails 110.

Two blank spaces extending over the entire length of the guide rails 110 are defined between the one ball thread 111 and the two guide rails 110 so as to allow the nut and the bracket to pass therethrough when the table 100 moves.

As shown in FIG. 1, the telescopic covers 1 are disposed on both sides of the table 100 in the axis L direction.

Each telescopic cover 1 includes a first cover piece (cover piece) 10, a second cover piece (cover piece) 20, and a third cover piece (cover piece) 30.

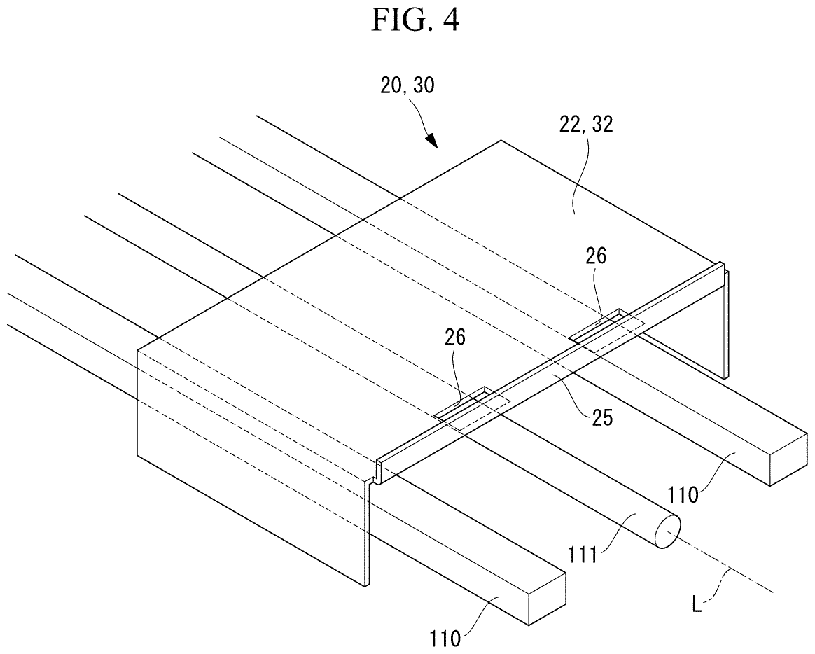

As shown in FIGS. 1 and 4, the first cover piece 10, the second cover piece 20, and the third cover piece 30 are formed by bending metal sheets around the axis L such that the metal sheets have U-shaped cross-sections having slightly different sizes, and are arranged sequentially in a nested manner. The internally and externally adjoining cover pieces 10, 20, and 30 are supported in a manner relatively movable in the axis L direction, such that portions thereof are kept overlapping by a link mechanism or the like (not shown).

The first cover piece 10 has an attachment part 13, which is formed by bending an edge of the first cover piece 10 in the axis L direction.

The attachment part 13 has a plurality of through-holes, into which bolts for fixing the first cover piece 10 to the table 100 are to be inserted.

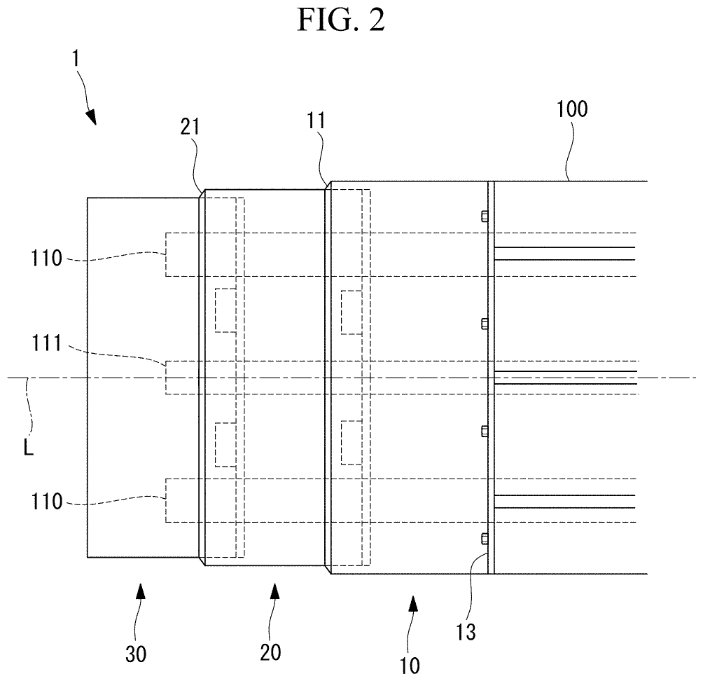

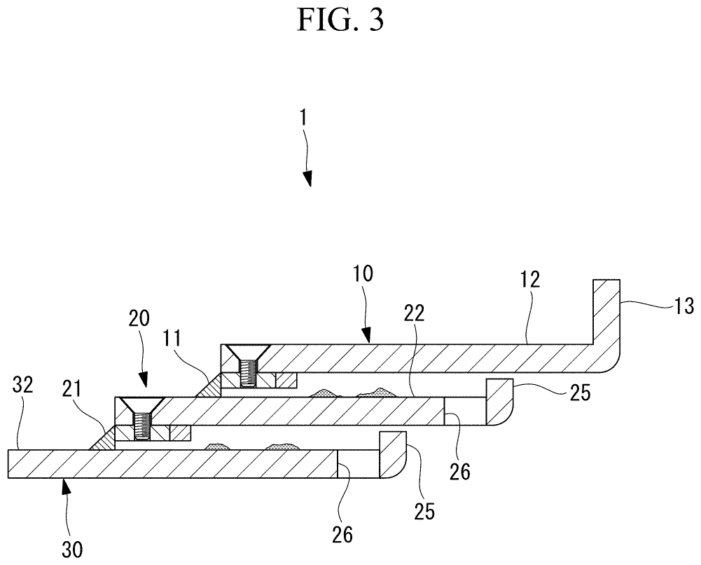

As shown in FIGS. 2 and 3, the first cover piece 10 and the second cover piece 20 have wipers 11 and 21, respectively, fixed to the edges (the other edges) opposite to the edges closer to the table 100, over the entire lengths thereof.

The wiper 11 of the first cover piece 10 is in tight contact with an outer circumferential surface (outer surface) 22 of the second cover piece 20 disposed on the inner side of the first cover piece 10, and the wiper 21 of the second cover piece 20 is in tight contact with an outer circumferential surface (outer surface) 32 of the third cover piece 30 disposed on the inner side of the second cover piece 20. The wipers 11 and 21 wipe off deposits on the outer circumferential surfaces 22 and 32 by being moved relative to the outer circumferential surfaces 22 and 32, respectively, when the telescopic cover 1 is expanded and contracted.

As shown in FIGS. 3 and 4, the second cover piece 20 and the third cover piece 30 each have a weir part 25 and cutaway parts 26 at the edge closer to the table 100.

As shown in FIG. 4, the weir parts 25 are formed in the shape of a brim standing vertically upright from the outer circumferential surfaces 22 and 32 by bending edges of horizontal portions of the second cover piece 20 and the third cover piece 30 over the entire lengths thereof.

The cutaway parts 26 are a plurality of through-holes penetrating in the thickness direction and provided in the horizontal portions of the second cover piece 20 and the third cover piece 30, at positions adjacent to the weir part 25. The cutaway parts 26 are provided at positions different from the guide rails 110 or the ball thread 111 in the horizontal direction perpendicular to the axis L, more specifically, at positions vertically above the two spaces between the guide rails 110 and the ball thread 111.

A fixing part (not shown) for fixing the third cover piece 30 to the base of the machine tool is provided at the edge of the third cover piece 30 opposite to the edge closer to the table 100.

The operation of the thus-configured telescopic covers 1 according to this embodiment will be described below.

The telescopic covers 1 are provided on both sides, in the axis L direction, of the table 100 provided in the machine tool, at positions covering the top and sides of the two guide rails 110 and the one ball thread 111.

The telescopic covers 1 are attached to the stage by fixing the attachment parts 13 of the first cover pieces 10 to the table 100 and fixing the fixing parts of the third cover pieces 30 to the base.

When the ball thread 111 is rotated in one direction about the axis L by the operation of the motor, the nut that is meshed with the ball thread 111 is moved in one direction along the axis L. As a result, the table 100 is guided by the guide rails 110 and is moved in one direction along the axis L. When the rotation direction of the ball thread 111 is reversed, the moving direction of the table 100 is also reversed.

When the table 100 is moved in the axis L direction, the first cover piece 10, the second cover piece 20, and the third cover piece 30 are moved relatively along the axis L in association with the movement of the table 100.

As a result, in the telescopic cover 1 on one side, the amounts of overlap among the adjoining cover pieces 10, 20, and 30 in the axis L direction decrease, and the overall length of the telescopic cover 1 increases. Furthermore, in the telescopic cover 1 on the other side, the amounts of overlap among the adjoining cover pieces 10, 20, and 30 in the axis L direction increase, and the overall length of the telescopic cover 1 decreases.

As a result, even when the position of the table 100 with respect to the base changes, the guide rails 110 and the ball thread 111 are kept covered by the pair of telescopic covers 1 disposed on both sides of the table 100 in the axis L direction without being exposed to the outside.

When the first cover piece 10 and the second cover piece 20 are moved relatively, the wiper 11 wipes off a large part of the cutting fluid and the like deposited on the outer circumferential surface 22 of the second cover piece 20. Furthermore, when the second cover piece 20 and the third cover piece 30 are moved relatively, the wiper 21 wipes off a large part of the cutting fluid and the like deposited on the outer circumferential surface 32 of the third cover piece 30.

A portion of the cutting fluid and the like remaining without being wiped off by the wipers 11 and 21 may pass through the wipers 11 and 21 and enter the inside of the first cover piece 10 or the second cover piece 20.

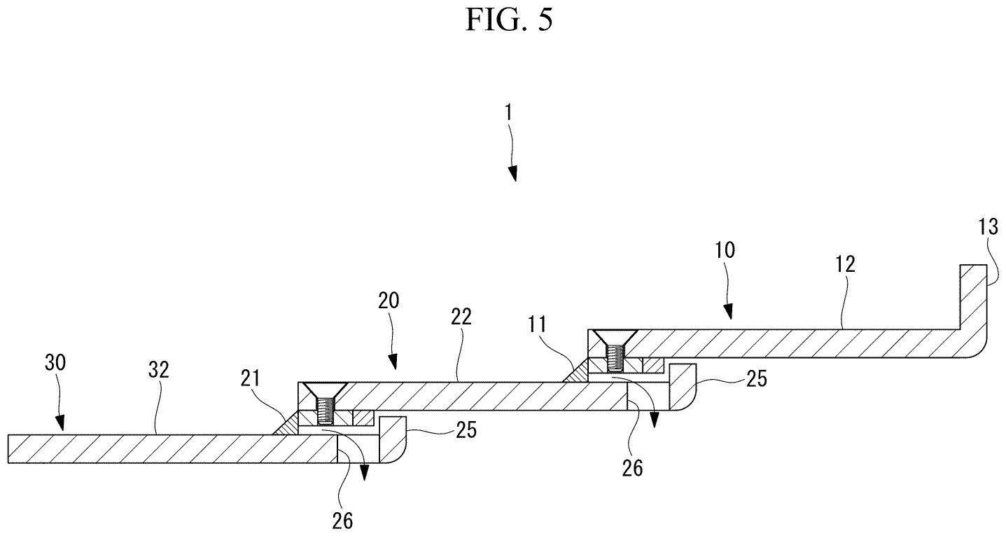

Then, as shown in FIG. 5, the cutting fluid and the like having entered the inside of the first cover piece 10 or the second cover piece 20 is scraped by the wipers 11 and 21 toward the table 100 when the telescopic cover 1 is extended.

The scraped cutting fluid and the like are stemmed by the weir part 25 on the edge of the second cover piece 20 or the third cover piece 30 and are prevented from being directly wiped out downward. Furthermore, a portion of the scraped cutting fluid and the like is discharged downward through the cutaway parts 26 provided in the second cover piece 20 or the third cover piece 30.

Because the cutaway parts 26 are provided vertically above the spaces between the guide rails 110 and the ball thread 111, the cutting fluid and the like discharged downward through the cutaway parts 26 do not fall on the guide rails 110 or the ball thread 111.

Specifically, even if the cutting fluid and the like enter the inside of the cover pieces 10 and 20 through the wipers 11 and 21, the cutting fluid and the like can be wiped out from the outer circumferential surfaces 22 and 32 of the cover pieces 20 and 30 at a position not falling on the guide rails 110 or the ball thread 111 below. This way, it is possible to protect the guide rails 110 and the ball thread 111. Furthermore, because the scraped cutting fluid and the like are discharged downward through the cutaway parts 26, it is also possible to prevent the cutting fluid and the like from overflowing the weir part 25.

Accordingly, there is no need to provide a chute for collecting the cutting fluid and the like flowing out of the weir part 25, as in the related art. As a result, the structures of the second cover piece 20 and the third cover piece 30 can be made more simple. Furthermore, because the cutting fluid and the like are discharged below the guide rails 110 and the ball thread 111 without being recovered, accumulation of chips and the like contained in the cutting fluid and the like is prevented.

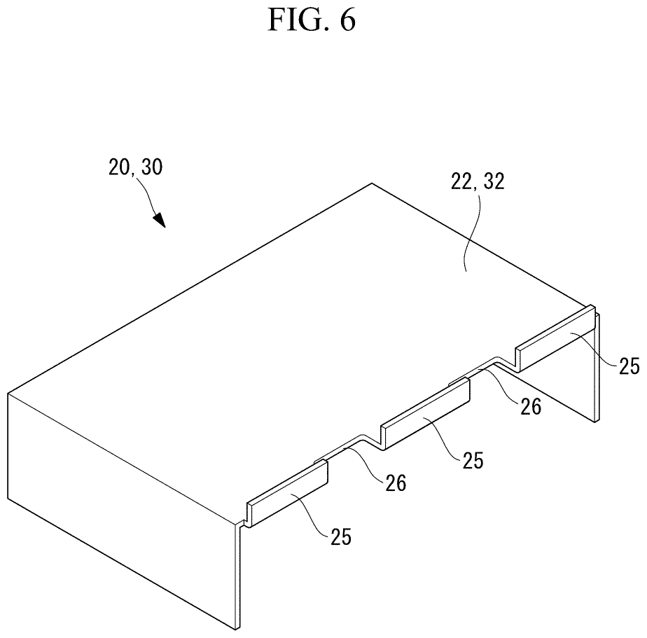

In this embodiment, the weir parts 25 are provided over the entire lengths of the edges of the horizontal portions of the second cover piece 20 and the third cover piece 30. Instead, as shown in FIG. 6, the horizontal portions of the second cover piece 20 and the third cover piece 30 and the weir parts 25 may be partially cut away to provide the cutaway parts 26. Alternatively, the cutaway parts 26 may be provided only in the weir parts 25.

In this embodiment, the weir parts 25 are formed by bending the edges of the second cover piece 20 and the third cover piece 30 at a right angle. Instead, the weir parts 25 may be formed by butting strip-shaped metal sheets against the edges of the horizontal portions of the second cover piece 20 and the third cover piece 30 and welding the metal sheets thereto.

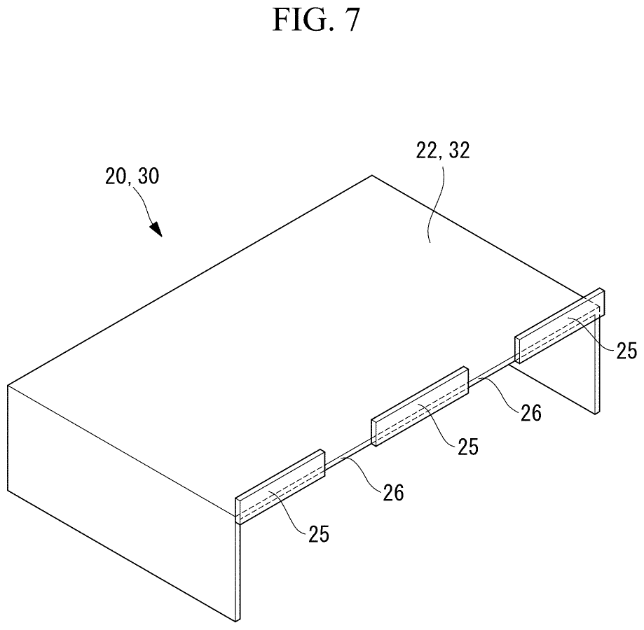

For example, as shown in FIG. 7, the weir parts 25 and the cutaway parts 26 may be formed by welding metal sheets to the edges of the second cover piece 20 and the third cover piece 30 closer to the table 100, at intervals in the direction along the edges.

Furthermore, in this embodiment, the second cover piece 20 and the third cover piece 30 may each have guide parts 27 that guide the liquid, such as the cutting fluid and the like, having passed through the cutaway parts 26 toward the middle of each cutaway part 26 in the horizontal direction.

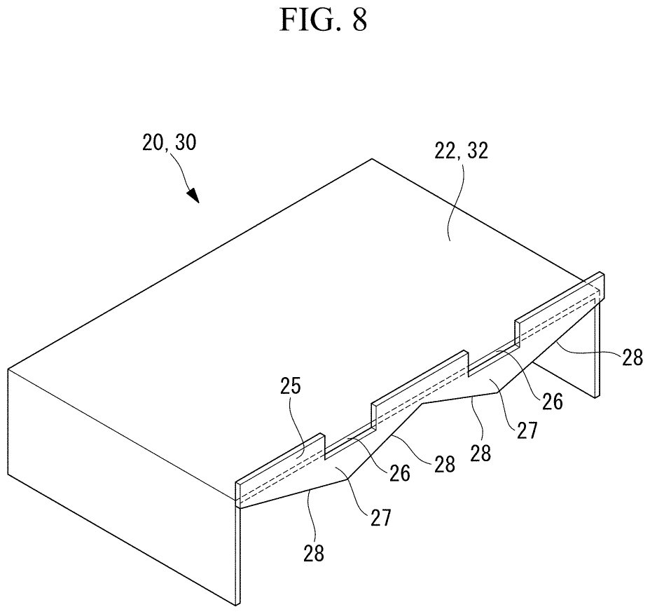

For example, as shown in FIG. 8, the guide parts 27 may be formed by providing, on the bottoms of the metal sheets to be welded to the edges of the second cover piece 20 and the third cover piece 30, inclined portions 28 extending downward toward the apexes substantially in the middle of the cutaway parts 26 in the horizontal direction.

When the cutting fluid and the like having passed through the cutaway parts 26 run down the metal sheets constituting the weir parts 25, the cutting fluid and the like flow along the inclined portions 28 of the guide parts 27 and are guided toward the apexes in the middle of the cutaway parts 26 in the horizontal direction. Thus, it is possible to discharge the cutting fluid and the like more reliably to positions away from the guide rails 110 and the ball thread 111, in the spaces between the guide rails 110 and the ball thread 111.

Furthermore, in this embodiment, although the telescopic cover 1 having three cover pieces 10, 20, and 30 has been shown as an example, the configuration is not limited thereto, and the telescopic cover 1 may have two, or four or more cover pieces.

Although the cutaway parts 26 that are rectangular through-holes have been shown as an example, the cutaway parts 26 are not limited thereto and may be one or more through-holes of any shape, such as a circular shape.

Furthermore, the configuration of the guide parts 27 is not limited to the one illustrated in FIG. 8, and guide parts of any other shape that guide the cutting fluid and the like to the middle of the spaces between the guide rails 110 and the ball thread 111 in the horizontal direction may be employed.

Furthermore, in this embodiment, although the linear motion mechanism having the two guide rails 110 and the one ball thread 111 has been described as an example, the linear motion mechanism is not limited thereto. Specifically, when the positions of the guide rails 110 and the ball thread 111 are different, the positions of the cutaway parts 26 may be changed accordingly. Furthermore, another actuator, such as a cylinder, may be used instead of the ball thread 111.

1. A telescopic cover for covering a linear motion mechanism in which a movable part is driven in a horizontal direction, the telescopic cover comprising:
a plurality of cover pieces arranged in a nested manner and supported in a movable manner in a driving direction of the movable part, wherein,
of two internally and externally adjoining cover pieces, an outer cover piece has a wiper for wiping an outer surface of an inner cover piece,
the inner cover piece has a weir part standing upright from the outer surface thereof toward an inner surface of the outer cover piece at an edge of an area constantly overlapping the outer cover piece, and a cutaway part formed by cutting away at least a portion of the weir part or the area to communicate between an inside and an outside of the inner cover piece, and
the cutaway part is provided at a position different from a position of the linear motion mechanism in the horizontal direction perpendicular to the driving direction.

2. The telescopic cover according to claim 1, wherein the cutaway part is formed by cutting away a portion of the weir part.

3. The telescopic cover according to claim 1, wherein
each cover piece is formed of a thin plate member, and
the cutaway part is a through-hole penetrating, in a thickness direction, the cover piece in the area.

4. The telescopic cover according to claim 1, wherein the inner cover piece includes a guide part that guides liquid having passed through the cutaway part toward a middle of the cutaway part in the horizontal direction.
